(19) United States
(12) Patent Application Publication
(10) Pub. No.: US 2007/0270010 A1
(43) Pub. Date: Nov. 22, 2007

(54) Portable hand loom and weaving method

(76) Inventor: Douglas B. Walter, New Bethlehem, PA (US)

Correspondence Address: MCKAY & ASSOCIATES, PC., 801 MCNEILLY ROAD, PITTSBURGH, PA, 15226, US

(21) Appl. No.: 11/748,559

(22) Filed: May 15, 2007

Related U.S. Application Data
(60) Provisional application No. 60/747,842, filed on May 22, 2006.

(51) Int. Cl. H01R 13/15

(52) U.S. Cl. 439/259

(57) ABSTRACT

The present invention is a hand-held loom, which includes a generally rectangular frame. A plurality of pins upstand from the top surface and are equally spaced thereon forming a row on each of the sides, with each pin in the rows being offset from an opposing pin in an opposing row, and wherein one row of the pins has an unequal number of pins as the opposing row of pins. Multiple markings are included on at least two opposing sides of the frame disposed on the top surface. A starting pin is disposed at one corner of said frame, and a starting pin indicator at a base of the starting pin indicates a position of the starting pin.

### SPECIFIC REFERENCE

This application claims benefit of provisional application Ser. No. 60/747,842, filed May 22, 2006.

### BACKGROUND

1. Field of Invention

This invention relates to weaving, and specifically to the weaving of small pieces of fabric on a hand-held loom, which can to be sewn together to form afghans, blankets, sweaters, etc.

2. Description of the Related Art

Prior art hand-held weaving devices which produce pieces of fabric have several disadvantages. Of particular importance is that uneven fabric and, at times, unusable fabric is produced on a hand-held loom as a result of the looms having certain disadvantageous pin arrangements. For example, in U.S. Pat. Nos. 2,607,979 and 2,118,142 the pins are not evenly spaced and the number of pins on all opposing sides equal in number. In combination, it is critical that the rows of pins be offset on opposing sides of the loom and they be evenly spaced, which the present invention provides. With such a structural combination then, an appropriate starting point must also be designated and indicated on the loom since some sides of the loom have a number of pins which is not the same as the opposing side. Finishing off the fabric piece is very important to keep the fabric pieces uniform and aesthetically appealing.

Prior art weaving devices, such as those described in U.S. Pat. Nos. 2,011,916 (1934) and 2,601,715 (1949), both to Donald R. Simonds, require that the yarn be tied off on itself at the beginning of weaving and again at the end. This is time consuming, difficult and produces uneven results. When the piece of fabric is pushed off the Simmons weaving devices and other prior art weaving devices, a yarn tail remains at the start corner and at the ending corner of the fabric. These tails have to be finished off. The fabric may be uneven if the knots are not tied off with the same tension. Also, the edges of the pieces of fabric made on these devices are scalloped, but they are not regular, particularly at the corners. Furthermore, they are difficult to align before sewing together.

The present invention improves on the prior art looms by providing a method of producing uniform fabric using a loom having, in part, offset rows of pins of equal spacing, which further vary in number. As a result of this configuration, starting points and indicia for finishing off the fabric must be provided and are provided along the periphery of the loom to allow for the consistent production of uniform fabric pieces.

### SUMMARY

Several objects and advantages of the present invention include, providing a weaving method which is totally portable; providing a weaving method which can be stopped and restarted at virtually any point in the process; providing a weaving method which is faster than previous methods; providing a weaving method which is easier to learn than previous methods; and providing a weaving method which will produce uniform pieces of fabric with the first use.

Accordingly, the present invention generally comprises a hand-held loom, which includes a frame having four sides, an underside, and a top surface. A plurality of pins upstand from the top surface and are equally spaced thereon forming a row on each of the sides, with each pin in the rows being offset from an opposing pin in an opposing row, and wherein one row of the pins has an unequal number of pins as the opposing row of pins. Multiple markings are included on at least two opposing sides of the frame disposed on the top surface. Each marking on one of the sides is situated medially between a pair of pins, and each marking is spaced a distance of three pins away from an adjacent marking and offset from an opposing marking on the opposing row, as is further shown by the figures. A starting pin is disposed at one corner of said frame, and a starting pin indicator at a base of the starting pin indicates a position of the starting pin.

As a further adjustable frame embodiment, the frame includes a movable frame piece having at least one hole defined at an end thereof adapted to receive an adjustment rod inserted through the frame. This allows the movable frame piece to be removably mounted within the four sides of the frame to vary the size of the frame.

### BRIEF DESCRIPTION OF THE DRAWINGS

FIG. 1 shows a perspective view of the hand-held loom.

FIG. 2 shows a top elevation view of the present invention.

FIG. 3 shows a top elevation view of the present invention with one pass of the yarn. The change in the row letters is a reflection of the loom being rotated one-quarter turn counter-clockwise.

FIG. 4 shows a top elevation view of the present invention with two passes of the yarn. Again, the change in the row letters is a reflection of the loom being rotated one-quarter turn clockwise.

FIG. 5 shows a top elevation view of the present invention with three passes of the yarn.

FIG. 6 shows a perspective view of the adjustable embodiment of the hand-held loom.

FIG. 7 shows an end view of the movable frame piece shown in the frame of FIG. 6.

FIG. 8 is an illustration of the underside of the movable frame piece and elongated base engaging with the stop of the adjustable frame.

### DETAILED DESCRIPTION OF THE PREFERRED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated kit assembly, and such further applications of the principles of the invention illustrated herein, as would normally occur to persons skilled in the art to which the invention relates. This detailed description of this invention is not meant to limit the invention, but is meant to provide a detailed disclosure of the best mode of practicing the invention.

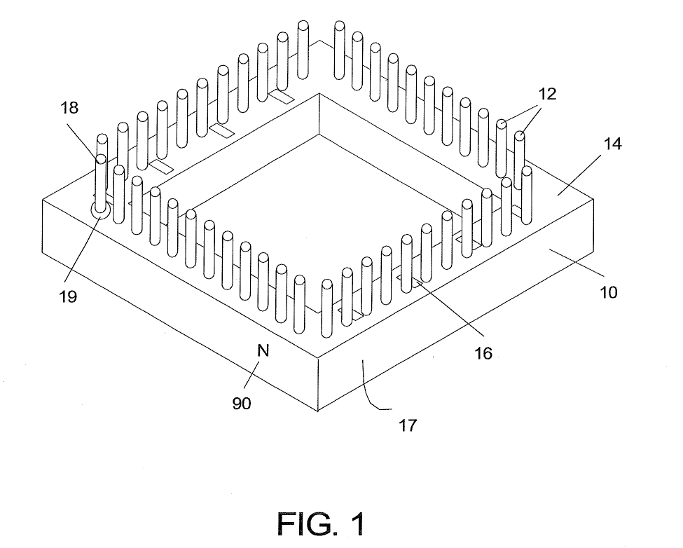

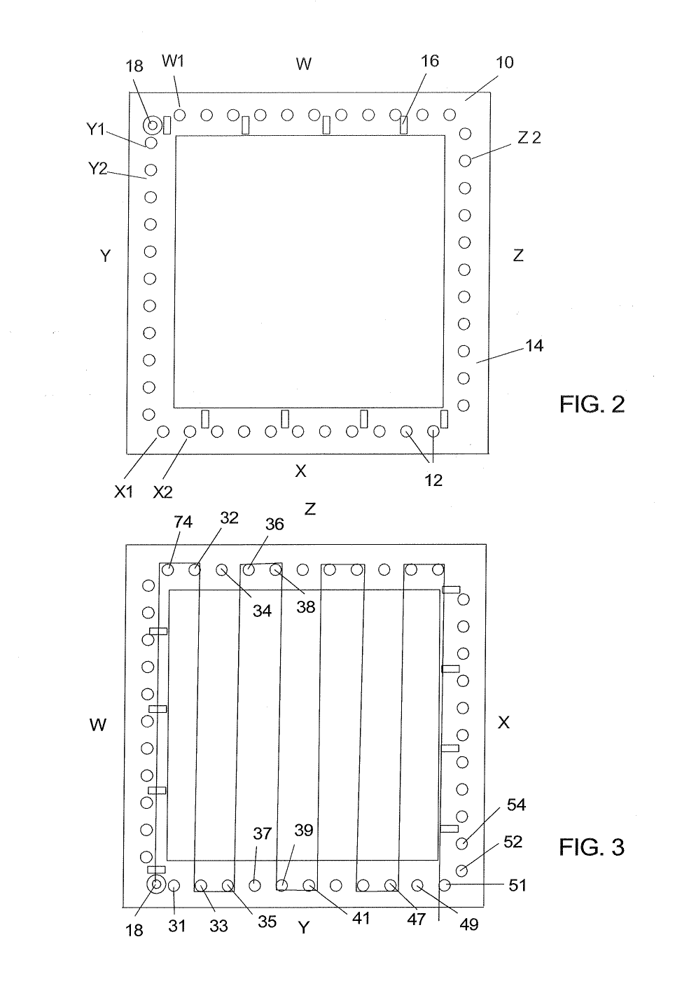

With reference then to FIGS. 1-2, a frame 10 has four sides, an underside 17, and a top surface 14. The frame 10 preferably is made of a hardwood square 2⅜ inches square with another square cut symmetrically out of the center. Understandably, the frame 10 can be made of many other dimensions and rigid materials including metals and plastics.

A plurality of pins 12 are fixed to the frame 10. The pins 12 are upstanding from the top surface 14 and equally spaced about the frame 10 to form a row on each of the sides of the frame 10 on the top surface 14. One row of pins 12 has an unequal number of pins 12 as the opposing row of pins. Furthermore, and with reference to FIG. 2, a pin in row W is not aligned with a pin in opposing row X, but rather axially offset. The equal spacing and offset pins is critical to form a nearly exact square piece of fabric since alignment would result in an angled pass of the yarn. Although not limited to one embodiment, the pins 12 can be made of 18 gauge steel wire ¾ inches long driven into the face of the frame. The pins are, in general, evenly spaced at ⅙ inch intervals. These pins can form a 2-inch square weaving plane.

Multiple markings 16 are disposed on at least two opposing sides of the frame 10. For example, rows W and X would include markings 16, whereas rows Y and Z would not need markings. Each marking 16 on one particular side (row W) is spaced a distance of three pins away from an adjacent marking on the same row but offset from the opposing marking on the opposing row (row X). The markings 16 can be etched into the frame 10 or painted or otherwise drawn on the frame 10. The critical purpose of the markings is to insure the correct placement of the needle between the correct pins when the weaving process begins and the needle with the yarn returns from a pass on the opposing row, as further described.

A starting pin 18 is disposed at one corner of the frame 10. As further described below, the starting pin 18 is the critical starting point for the looming method The yarn is tied to the starting pin 18 using a slipknot.

The starting pin 18 is indicated on the frame 10 by providing a starting pin indicator 19 at the base of the starting pin 18. The starting pin indicator 19 can be made in a fashion similar to the multiple markings 16.

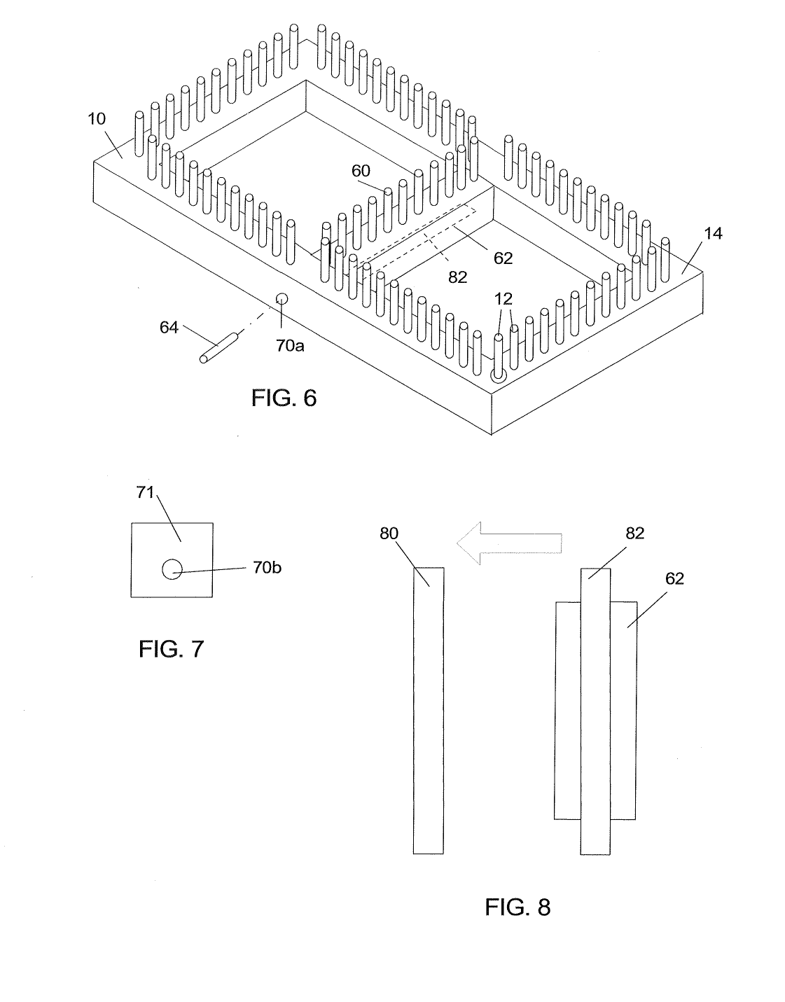

As a further embodiment and with reference to FIGS. 6-8, shown is a version of the frame 10 which is adjustable. Specifically, the hand-held loom frame 10 includes an elongated stop 80 connected to the underside 17 of the frame 10, extending perpendicularly from one of the sides to an opposing side. Generally then, the stop 80 splits the rectangular frame 10 into two rectangles such that only one of the rectangles is utilized for producing the fabric piece. A movable row of pins 60 is mounted to a movable frame piece 62. The movable row of pins would be identical in form to the pins 12 on the top surface 14 of the frame 10. The moveable frame piece 62 has at least one hole 70b defined at an end 71 thereof adapted to receive an adjustment rod 64, which passes therethrough and into the frame hole 70a. The rod 64 can be a screw or pin or any other similar means for connecting the moveable frame piece 62 to the frame 10. In this manner the movable frame piece 62 is adapted to be removably mounted within the four sides of the frame 10 to vary the size of the frame 10 and thus the size of the workable rectangular and thus the size of the fabric piece. This is made possible by providing the movable frame piece with an elongated base 82 medially situated at an underside of the movable frame piece 62 for engaging the elongated stop 80, as shown by FIG. 8. For example, if the moveable frame piece 62 is used, a square of fabric can be produced, but if the moveable frame piece is not used and removed from the frame 10, a larger rectangular piece of fabric can be produced. It should also be understood that the moveable frame piece 62 can travel the length of the frame 10 if the adjustable frame included more than one elongated stop 80.

In use then, and for the hand-held looming method using the present invention to create a piece of fabric, the following instructional method is provided, with reference to FIGS. 3-5.

Step 1: Layer One

A strand of yarn is tied to the specifically designated starting pin in the first row of pins on the frame. Yarn is tied to starting pin 18 using a slipknot. As heretofore disclosed, this starting pin 18 is marked as the start pin. The yarn is then looped around pins 74 and 32. As shown in the diagrams, pins 74 and 32 are a pair of pins in a second row of pins which oppose the first. For instance, if the starting pin 18 is on row Y as shown, the opposing pair of pins is on row Z. Next, the yarn is returned and looped around a pair of pins two pins away from the starting pin in row Y. Thus, the yarn is passed between pins 31 and 33 on its return and looped around pins 33 and 35. The yarn is then passed between pins 34 and 36 and looped around pins 36 and 38. The yarn is then passed between pins 37 and 39 and looped around pins 39 and 41. See FIG. 3. As can be seen, the yarn is intermittently looped around every pair of pins on each row while leaving one pin free between each looped pair. This will occur until the yarn passes between two pins away from a finishing corner. Thus, a pattern can be seen as the yarn is placed on the hand loom. As the yarn is brought to one side of the loom, one pin is skipped and the yarn is looped around the next two pins. This pattern is continued until the yarn passes between pins 49 and 51.

Step 2: Layer Two

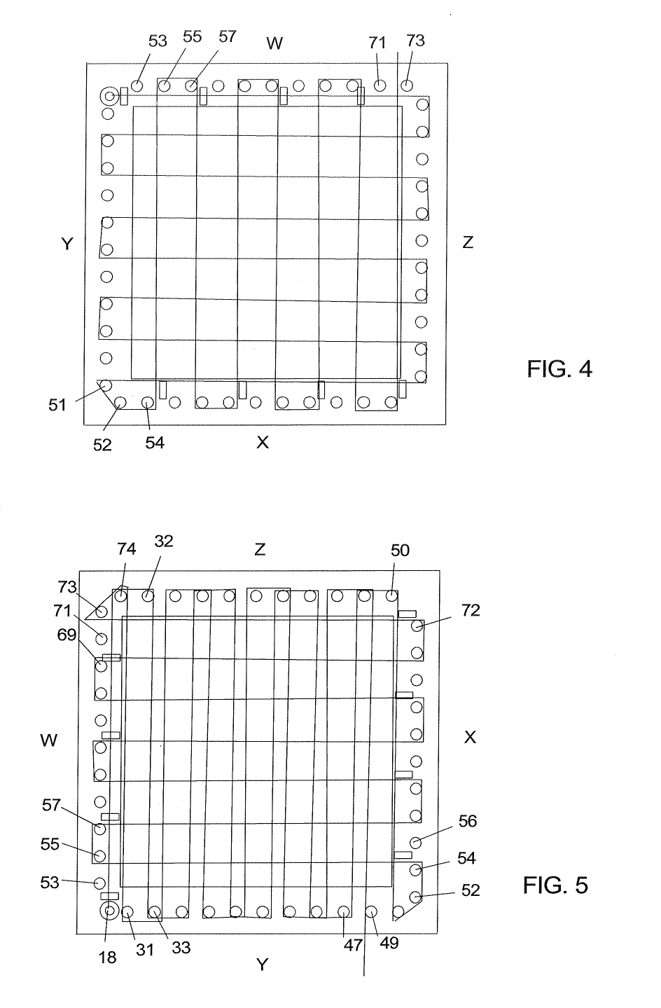

The yarn is then looped around pins 51, 52 and 54. See FIG. 4 for example, shown as a rotation of FIG. 3. 51 and 52 are considered to be one pin during this process. Therefore, the loading pattern observed above continues. The yarn is passed between pins 53 and 55 and looped around pins 55 and 57. The pattern observed on FIG. 3 (yarn skips one pin and is looped around the next two) is repeated until the yarn passed between pins 71 and 73.

Step 3: Layer Three

With reference then to FIG. 5, the yarn is then looped around pins 73 and 74. The yarn is then passed between pins 18 and 31 and looped around pins 31 and 33. The observed pattern is followed until the yarn passes between pins 47 and 49. See FIG. 5. It can be observed that as the yarn is loaded during this step it is parallel and between the yarns loaded in the first step on FIG. 3.

Step 4: Weaving

Slack yarn for weaving is measured by loosely winding yarn around the outside of the pins 2½ times (3½ times for a three-inch loom, 4½ times for a four-inch loom, etc.). Thus, to obtain an appropriate length of slack yarn, the yarn is wound around the pins a number of times equal to N. This number, N, termed herein slack yarn number 90, varies from loom to loom but is marked on the edge of the frame, for instance between pins 47 and 49 (see FIG. 1). Thus, the yarn is wound around the outside of all of the rows, thereby forming slack yarn the length of the slack yarn number. The slack yarn is cut at this point and removed from the frame. Only the slack yarn is removed from the frame. The frame should appear as it did at the end of FIG. 5. This slack yarn is threaded through a needle (not shown). The threaded needle is passed over the loop of yarn on the outside of pins 52 and 54 then between these pins. The needle is pushed under the next yarn then over the next and so on until the needle passes under the last yarn and is pushed out of the other side of the loom between pins 18 and 53. Note how the marking disposed between pins 18 and 53 aid in locating the exit point of the needle. The needle is pulled out of the hand loom at this point along with all the slack yarn. The needle is then passed over the loop of yarn on the outside of pins 55 and 57. This line is woven similar to the first line. This line passes under the last yarn and between pins 54 and 56. This process is repeated until the needle passes under the last yarn and out of the loom between pins 69 and 71 at the next marker point. Finally, starting over the yarn between pins 73 and 74 the needle is passed parallel to the pins of row Z and out at the final marking between 50 and 72.

Step 5: Finishing Corners

The needle is then woven between the last two lines of fabric by starting over the first yarn, alternately under and over yarns and finally coming out of the loom between pins 71 and 73. The needle may have to be rethreaded after it has partially woven through the fabric as there may not be enough slack to reach the eye of the needle at the beginning of this step. Any slack yarn that extends past the edge of the fabric is cut off flush with the edge of the fabric.

The start corner is finished off in a similar manner. The slipknot is pushed off pin 18 and the knot removed. The needle is woven starting under the yarn between pins 18 and 31 and between the two yarns on the left of the fabric. This is the only place in the weaving process when the needle passes under the yarn first. The needle is woven alternately under and over the yarns and the tip passes between pins 74 and 32. The slack yarn removed from pin 18 is then threaded through the needle and the slack pulled through the fabric. Yarn is not looped around pin 18. This pin is only used to anchor the yarn at the beginning. Any excess slack yarn that extends past the edge of the fabric is cut off flush with the edge of the fabric.

Before pushing the piece of fabric off the frame from the bottom, the operator should determine that the square is uniform. Any deformity can be adjusted with the needle.

The hand loom and process described above will produce uniform squares of fabric. The preferred embodiment may be altered to build hand looms that will produce different sized squares of fabric, different shaped pieces of fabric or to create fabric with a tighter of looser thread count.

Different sized squares of fabric can be made on a frame that has a different number of pins. Pins are simply added to the preferred embodiment to make a larger square and subtracted to make a smaller square. These pins have to be added or subtracted on all sides in groups of three. Of course, the frame size would have to be adjusted to accommodate the different sized weaving plane. If the size of the square is changed, the amount of slack yarn needed to do the weaving would also change and the number of times the yarn is wound around the pins would have to be determined for each new embodiment and marked on the edge of the frame. Also, the needle used to do the weaving would have to be either longer or shorter.

Rectangular pieces of fabric can be made on frames that also have a different number of pins. With this embodiment, pins are added or subtracted in equal numbers of groups of three to opposite sides of the loom. Again, the frame size would have to be adjusted to accommodate the different sized weaving plane. Also, the amount of slack yarn would have to be determined and marked on the edge of the frame. A proper length needle would have to be provided.

A tighter or looser thread count can be achieved by altering the spacing of the pins. Spacing can range from ⅛^{th} inch to one inch and possibly more. Changing the thread count may be desired to either make a tighter or looser weave or to allow for different weight yarns. With the proper pin spacing, hand looms could be made to weave almost any type of weaving material from thread through heavy yarns or even light cords and ropes. Once again, the frame size and needle length would have to be adjusted to accommodate the different sized weaving plane. Also, the amount of slack yarn would have to be determined.

I claim:

1. A hand-held loom, comprising:
a frame having four sides, an underside, and a top surface;
a plurality of pins upstanding from said top surface and equally spaced thereon forming a row on each of said sides, each said pin in said row being offset from an opposing pin in an opposing row, and wherein one row of said pins has an unequal number of pins as said opposing row of said pins;
a starting pin disposed at one corner of said frame; and,
a starting pin indicator at a base of said starting pin indicating a position of said starting pin.

2. The hand-held loom of claim 1, further comprising a slack yarn number disposed on said frame indicating a desired length of slack yarn.

3. The hand-held loom of claim 1, further comprising multiple markings on at least two opposing sides of said frame disposed on said top surface, each of said markings on one of said sides situated medially between a pair of said pins, and wherein each said marking is spaced a distance of three pins away from an adjacent marking and offset from an opposing marking on said opposing row.

4. The hand-held loom of claim 1, further comprising an elongated stop connected to said underside of said frame extending from one of said sides to an opposing side.

5. The hand-held loom of claim 4, further comprising a movable row of pins mounted to a movable frame piece;
said movable frame piece having at least one hole defined at an end thereof adapted to receive an adjustment rod inserted through said frame, wherein said movable frame piece is adapted to be removably mounted within said four sides to vary the size of said frame.

6. The hand-held loom of claim 5, wherein said movable frame piece includes an elongated base medially situated at an underside of said movable frame piece for engaging said elongated stop.

7. A hand-held loom, comprising:
a frame having four sides, an underside, and a top surface;
a plurality of pins upstanding from said top surface and equally spaced thereon forming a row on each of said sides, each said pin in said row being offset from an opposing pin in an opposing row, and wherein one row of said pins has an unequal number of pins as said opposing row of said pins;
multiple markings on at least two opposing sides of said frame disposed on said top surface, each of said markings on one of said sides situated medially between a pair of said pins, and wherein each said marking is spaced a distance of three pins away from an adjacent marking and offset from an opposing marking on said opposing row;
a starting pin disposed at one corner of said frame; and,
a starting pin indicator at a base of said starting pin indicating a position of said starting pin.

8. The hand-held loom of claim 7, further comprising a slack yarn number disposed on said frame indicating a desired length of slack yarn

9. The hand-held loom of claim 7, further comprising an elongated stop connected to said underside of said frame extending from one of said sides to an opposing side.

10. The hand-held loom of claim 9, further comprising a movable row of pins mounted to a movable frame piece;
said movable frame piece having at least one hole defined at an end thereof adapted to receive an adjustment rod inserted through said frame, wherein said movable frame piece is adapted to be removably mounted within said four sides to vary the size of said frame.

11. The hand-held loom of claim 10, wherein said movable frame piece includes an elongated base medially situated at an underside of said movable frame piece for engaging said elongated stop.

12. A hand-held looming method of forming a fabric piece, comprising the steps of:
tying a strand of yarn to a specifically designated start pin in a first row of pins on a frame;
looping said yarn around a pair of pins in a second row of pins opposing said first row;
looping said yarn around a pair of pins two pins away from start pin on said first row;
intermittently looping said yarn around every pair of pins on each row and leaving one pin free between each looped pair until said yarn passes between two pins away from a starting pin;
winding said yarn around an outside of all of said rows, thereby forming slack yarn;
cutting said slack yarn; and,
using said slack yarn in combination with a needle to weave on said frame.

13. The method of claim 12, further comprising the step of finishing off corners of said fabric piece.

14. The method of claim 12, wherein for the step of winding said yarn, to obtain an appropriate length of said slack yarn, said yarn is wound around said pins a number of times N, wherein N is equal to a slack yarn number marked on said frame.

15. The method of claim 12, further comprising the step of pushing said fabric piece off of said frame such that said fabric piece can be sewn to another fabric piece.
